(19) United States
(12) Patent Application Publication
(10) Pub. No.: US 2011/0210695 A1
(43) Pub. Date: Sep. 1, 2011

(54) CHARGING APPARATUS, PROGRAM

(75) Inventor: Mamoru Kubo, Isesaki-shi (JP)

(73) Assignee: SANYO ELECTRIC CO., LTD., Osaka (JP)

(21) Appl. No.: 13/035,368

(22) Filed: Feb. 25, 2011

(30) Foreign Application Priority Data
Feb. 26, 2010 (JP) 2010-043074

(51) Int. Cl. H02J 7/04

(52) U.S. Cl. 320/107

(57) ABSTRACT

A charging apparatus includes: a charging circuit configured to charge a secondary battery; and a control circuit configured to control an operation of the charging circuit, the control circuit including a control unit configured to control the charging circuit so that the secondary battery is charged with a constant current until a time when a battery voltage of the secondary battery goes to a first voltage, control the charging circuit so that the secondary battery is charged with a current smaller than the constant current when the battery voltage goes to the first voltage, and control the charging circuit so that the secondary battery is charged with a constant voltage when the battery voltage goes to a second voltage higher than the first voltage.

### CROSS-REFERENCE TO RELATED APPLICATION

This application claims the benefit of priority to Japanese Patent Application No. 2010-043074, filed Feb. 26, 2010, of which full contents are incorporated herein by reference.

### BACKGROUND OF THE INVENTION

1. Field of the Invention

The present invention relates to a charging apparatus and a program.

2. Description of the Related Art

As a method for charging a lithium-ion battery, known is a method for charging a battery with a constant current until a battery voltage reaches a desired voltage, and thereafter charging with a constant voltage, for example (See Japanese Patent Laid-Open Publication No. 2006-129655, for example).

If the voltage when switching is performed from constant-current charging to constant-voltage charging is deviated from a desired voltage, such a problem might occur that a charge amount of the lithium-ion battery is deviated from a desired value, for example. Thus, the charging apparatus needs to make the voltage when switching is performed from the constant-current charging to the constant-voltage charging equal to the desired voltage with accuracy.

In order to reduce a charging time of the lithium-ion battery, a current value of the constant-current charging, that is, a current value of a charging current needs to be increased. However, in general, if the current value of the charging current is increased, noise level such as ripple contained in the charging current is also raised. Also, since there is internal resistance in the lithium-ion battery, if the noise level of the charging current is raised, the battery voltage is also affected by the noise. Therefore, in this case, it is difficult to cause the charging apparatus to start constant-voltage charging when the voltage becomes the desired battery voltage.

### SUMMARY OF THE INVENTION

A charging apparatus according to an aspect of the present invention, includes: a charging circuit configured to charge a secondary battery; and a control circuit configured to control an operation of the charging circuit, the control circuit including a control unit configured to control the charging circuit so that the secondary battery is charged with a constant current until a time when a battery voltage of the secondary battery goes to a first voltage, control the charging circuit so that the secondary battery is charged with a current smaller than the constant current when the battery voltage goes to the first voltage, and control the charging circuit so that the secondary battery is charged with a constant voltage when the battery voltage goes to a second voltage higher than the first voltage.

Other features of the present invention will become apparent from descriptions of this specification and of the accompanying drawings.

### BRIEF DESCRIPTION OF THE DRAWINGS

For more thorough understanding of the present invention and advantages thereof, the following description should be read in conjunction with the accompanying drawings, in which:

FIG. 1 is a diagram illustrating a configuration of a charging apparatus 10 according to an embodiment of the present invention;

FIG. 2 is a diagram illustrating a functional block realized by a CPU 52;

FIG. 3 is a diagram illustrating an example of a waveform of a charging current Ic generated between voltages V1 and V2;

FIG. 4 is a flowchart illustrating an example of processing executed by the CPU 52;

FIG. 5 is a diagram illustrating an example of a change of a battery voltage Vbat and a charging current Ic when a battery 15 is charged;

FIG. 6 is a diagram illustrating an example of a waveform of a charging current Ic generated between voltages V1 and V2; and

FIG. 7 is a diagram illustrating an example of a change of a battery voltage Vbat and a charging current Ic when a battery 15 is charged.

### DETAILED DESCRIPTION OF THE INVENTION

At least the following details will become apparent from descriptions of this specification and of the accompanying drawings.

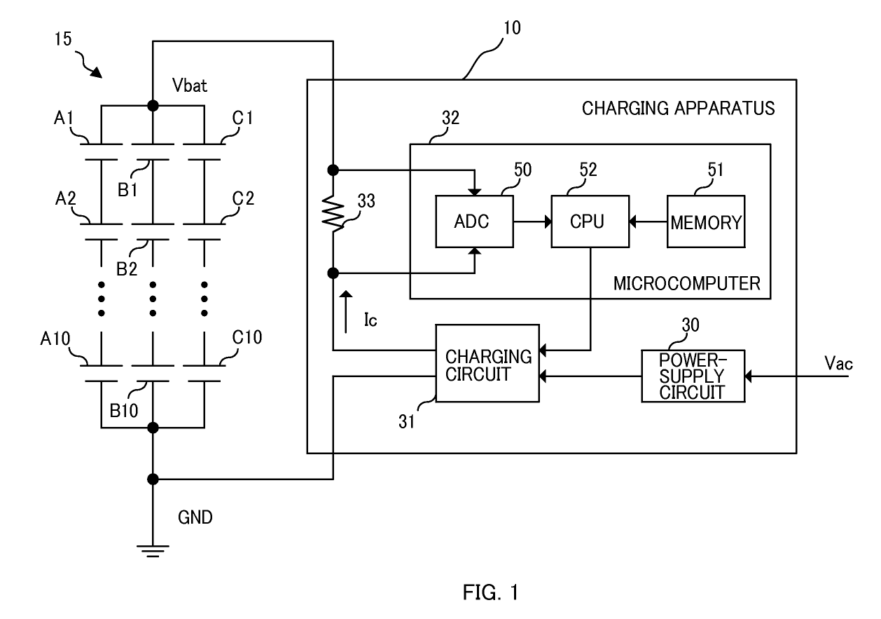

FIG. 1 is a diagram illustrating a configuration of the charging apparatus 10 according to an embodiment of the present invention. The charging apparatus 10 is a device configured to charge a battery 15 when a commercial power supply voltage Vac is inputted. The charging apparatus 10 includes a power-supply circuit 30, a charging circuit 31, a microcomputer 32, and a resistor 33.

The battery 15 (secondary battery) is a so-called battery pack including 30 lithium-ion batteries, for example, and includes lithium-ion batteries A1 to A10, B1 to B10, and C1 to C10. In the battery 15, each group of the serially connected lithium-ion batteries A1 to A10, B1 to B10, and C1 to C10 are connected in parallel. The battery 15 generates a battery voltage Vbat.

The power-supply circuit 30 is an AC-DC converter configured to generate a DC current for operating the charging circuit 31 from the commercial power supply voltage Vac.

The charging circuit 31 charges the battery 15 on the basis of an instruction from the microcomputer 32. Specifically, a voltage and a current in accordance with the instruction from the microcomputer 32 are generated, so as to charge the charging circuit 31.

The microcomputer 32 is a circuit that integrally controls the charging apparatus 10, and includes an AD converter (ADC) 50, a memory 51, and a CPU (Central Processing Unit) 52.

The resistor 33 is a current detecting resistor configured to detect the charging current Ic of the charging circuit 31, and is provided between the charging circuit 31 and a positive electrode of the battery 15.

The AD converter 50 converts the battery voltage Vbat and the voltage generated in the resistor 33 into digital data.

The memory 51 (storage unit) stores program data to be executed by the CPU 52 and various types of data to be used by the CPU 52 when executing the program, for example.

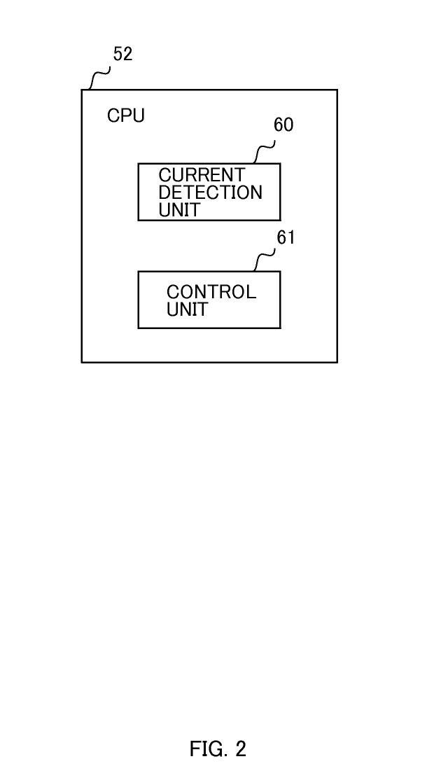

The CPU 52 executes the program data to be stored in the memory 51, so as to realize various functions. Specifically, the CPU 52 realizes functions of a current detection unit 60 and a control unit 61 as shown in FIG. 2.

The current detection unit 60 calculates the charging current Ic on the basis of the voltage of the resistor 33 to be outputted from the AD converter 50.

The control unit 61 controls the charging circuit 31 on the basis of the battery voltage Vbat outputted from the AD converter 50, the charging current Ic obtained by calculating in the current detection unit 60, and the data stored in the memory 51. Also, the control unit 61 controls the charging circuit 31 so that the charging current Ic is decreased when the battery voltage Vbat of the battery 15 gets close to the voltage for constant-voltage charging.

Specifically, until the battery voltage Vbat goes to a predetermined voltage V1 (first voltage), the control unit 61 causes the charging circuit 31 to charge the battery 15 with a constant current IA of a current value I1. Also, when the battery voltage Vbat goes to the voltage V1, the control unit 61 causes the charging circuit 31 to charge the battery 15 with a current IB smaller than the constant current IA. Then, when the battery voltage Vbat is raised to a voltage V2 (second voltage), the control unit 61 causes the charging circuit 31 to charge the battery 15 with the constant voltage VA. That is, if the voltage goes to the voltage V2, constant-voltage charging is started. If the charging current Ic of the battery 15 that is charged with a constant voltage is decreased and goes to a current value I2 (second current value), the control unit 61 causes the charging circuit 31 to stop charging of the battery 15. As a result, supply of the charging current Ic is stopped. That is, the current value I2 is a value of the charging current Ic when charging is finished.

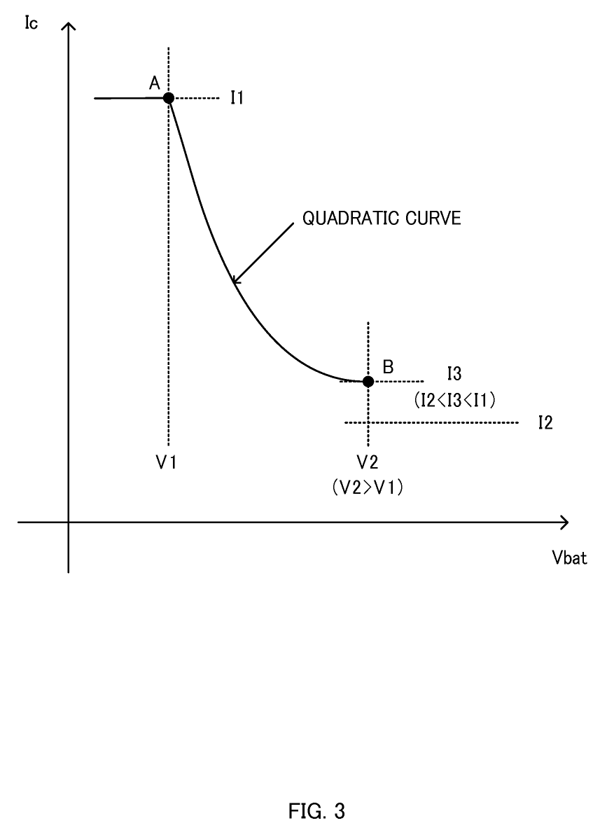

The control unit 61 controls the charging circuit 31 on the basis of the battery voltage Vbat and the data stored in the memory 51 while the battery voltage Vbat is between the voltages V1 to V2. The memory 51 according to an embodiment of the present invention stores data for causing the charging circuit 31 to generate the charging current Ic according to the level of the battery voltage Vbat. Here, the above-described data is, as shown in FIG. 3, for example, data for causing the charging circuit 31 to generate the charging current Ic, which is decreased in a relationship of a quadratic curve projecting downward. The data for generating the charging current Ic, which is decreased in the relationship of the quadratic curve, will be hereinafter referred to as first control data. The quadratic curve includes a point A, which is determined by the voltage V1 and the current value I1 of the constant current IA, and a point B, which is determined by the voltage V2 and a current value I3 of the charging current Ic when the voltage is the voltage V2, and is determined such that the point B is a vertex. The current value I3 (first current value) at the point B is a value smaller than the current value I1 of the constant current IA and greater than the current value I2.

== Example of Operation of Charging Apparatus 10 ==

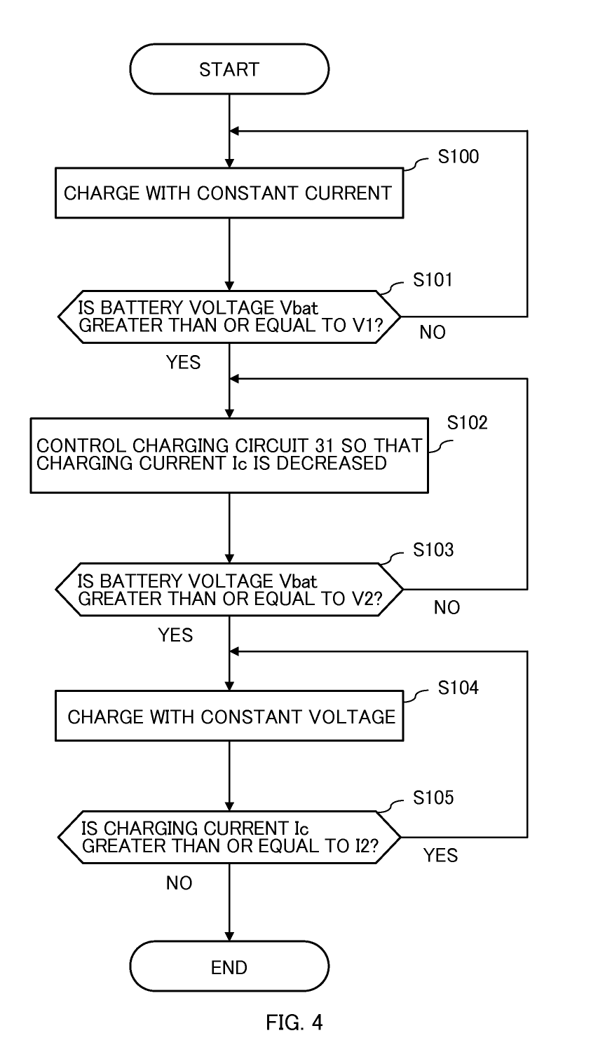

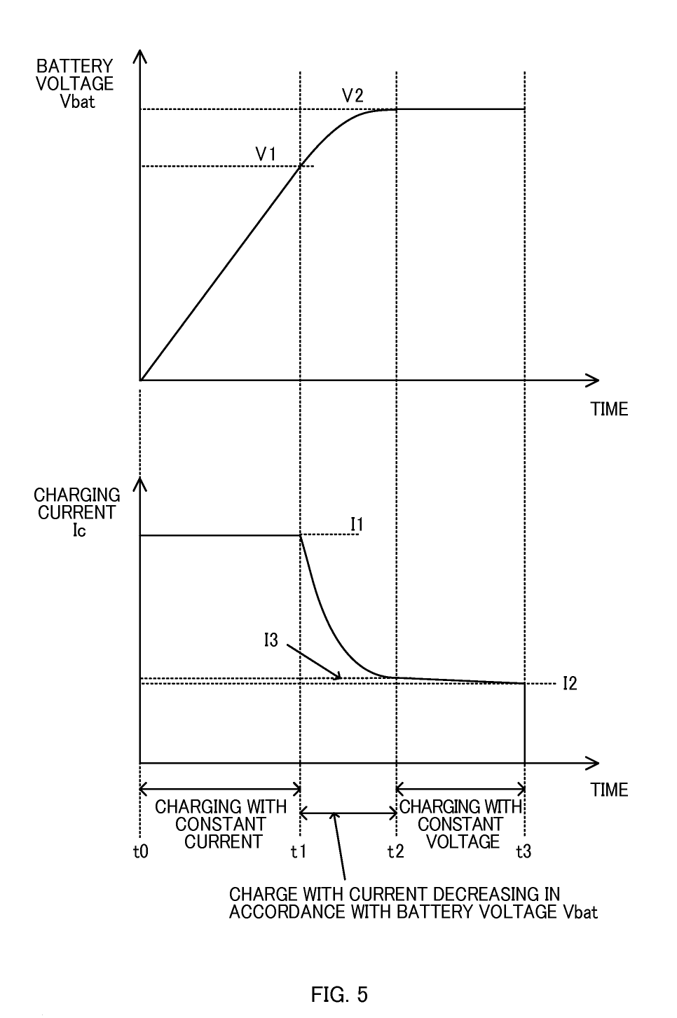

Here, referring to FIGS. 4 and 5, an example of an operation of the charging apparatus 10 will be described. FIG. 4 is an example of processing executed by the CPU 52, and FIG. 5 is a diagram illustrating changes in the battery voltage Vbat and the charging current Ic when the charging apparatus 10 charges the battery 15. Also, it is assumed here that the battery 15 has been discharged.

First, at time t0, the control unit 61 causes the charging circuit 31 to charge the battery 15 with the constant current 1A (S100). Thus, at the time t0 and thereafter, the battery voltage Vbat is raised. And the control unit 61 determines whether or not the battery voltage Vbat is greater than or equal to the voltage V1 (S101). If the battery voltage Vbat is smaller than the voltage V1 (S101: NO), processing 100 is executed. On the other hand, for example, if the battery voltage Vbat is raised and goes to the voltage V1 at time t1 (S101: YES), the control unit 61 controls the charging circuit 31 so that the charging current Ic is decreased from the current value I1 (S102). Specifically, the control unit 61 controls the charging circuit 31 so that the charging current Ic is changed in the above-described relationship of the quadratic curve on the basis of the first control data stored in the memory 51 and the battery voltage Vbat. As a result, the charging current Ic is decreased, and the increase of the battery voltage Vbat becomes slow. Also, the control unit 61 determines whether or not the battery voltage Vbat is greater than or equal to the voltage V2 (S103). If the battery voltage Vbat is smaller than the voltage V2 (S103: NO), processing 102 is executed. On the other hand, for example, if the battery voltage Vbat is increased at time t2 and goes to the voltage V2 (S103: YES), the control unit 61 controls the charging circuit 31 such that the battery 15 is charged with the constant voltage VA (S104). As a result, the battery 15 is charged with a constant voltage. Thereafter, the control unit 61 determines whether or not the charging current Ic is greater than or equal to the current value I2 indicating that the charging is finished (S105). If the charging current Ic is smaller than the current value I2 (S105: NO), processing 104 is executed. On the other hand, for example, if the charging current Ic is decreased at time t3 and goes to the current value I2 (S105: YES), the control unit 61 finishes the charging of the battery 15.

== If Control Unit 61 Controls Charging Circuit 31 on the Basis of Another Control Data ==

Here, a description will be given of a case in which the control unit 61 controls the charging circuit 31 on the basis of another control data different from the first control data.

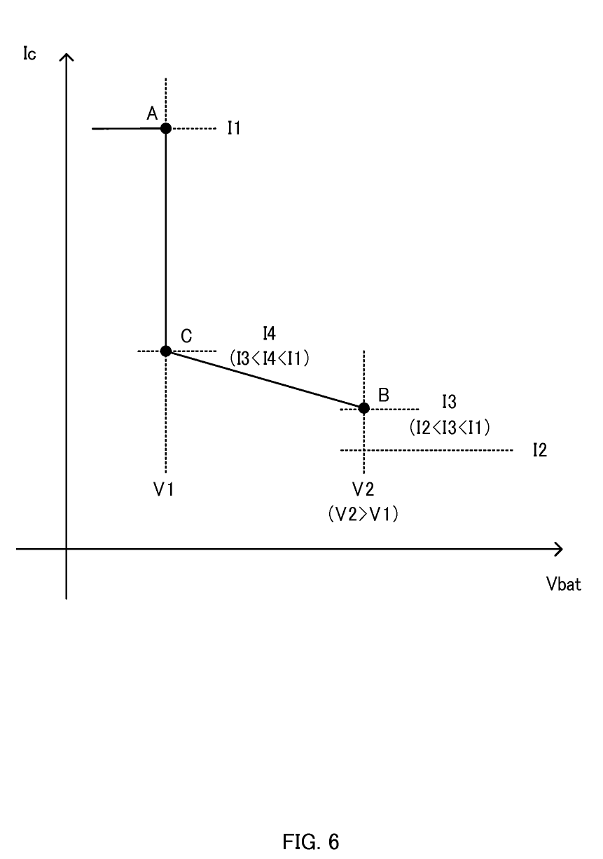

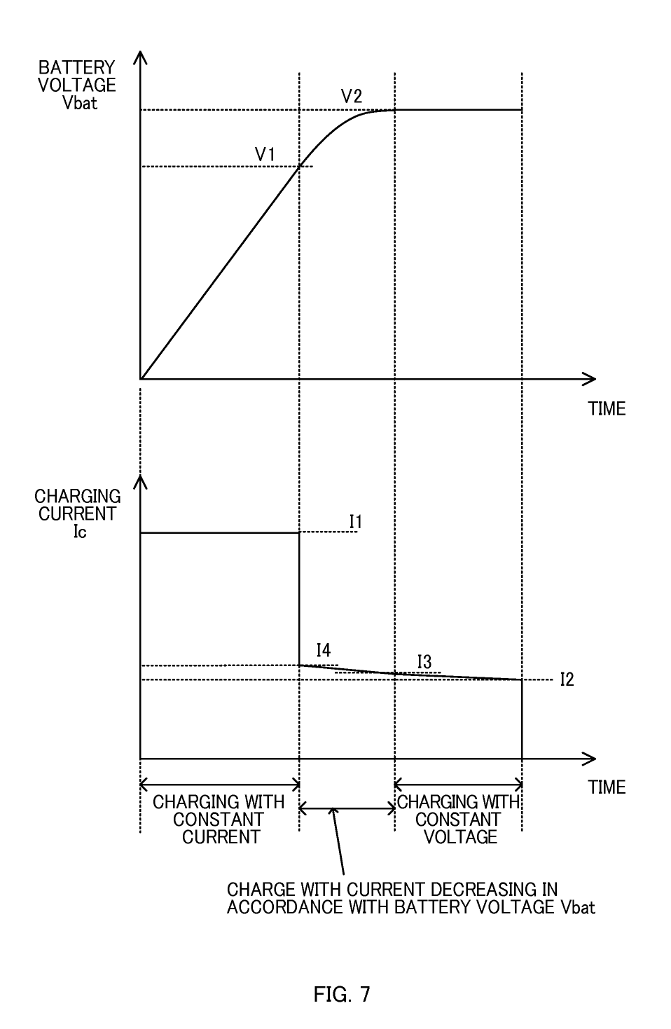

In this case, it is assumed that the memory 51 stores second control data for causing the charging circuit 31 to generate the charging current Ic according to the level of the battery voltage Vbat. Here, the second control data is, as shown in FIG. 6, for example, data for causing the charging circuit 31 to generate the charging current Ic with a current value I4 at the voltage V1, and further causes the charging circuit 31 to generate the charging current Ic, which is decreased linearly in accordance with an increase of the battery voltage Vbat. The current value I4 is a value smaller than the current value I1 of the constant current IA and greater than the current value I3. The charging current Ic in this case is determined on the basis of a point C, which is determined by the voltage V1 and the current value I4, and the point B, which is determined by the voltage V2 and the current value I3. Thus, if the control unit 61 obtains the second control data stored in the memory 51 and the battery voltage Vbat, the charging circuit 31 generates the charging current Ic in the relationship as shown in FIG. 6. Even if the control unit 61 controls the charging circuit 31 on the basis of the second control data and the battery voltage Vbat, the processing to be executed by the CPU 52 is the same as in the above-described FIG. 4. Therefore, though detailed description is omitted, the battery voltage Vbat and the charging current Ic in this case are changed as in FIG. 7, for example.

The charging apparatus 10 according to an embodiment of the present invention was described hereinabove. The charging current Ic from the charging circuit 31 contains noise such as ripple which is increased more as the current value of the charging current Ic is increased. The battery 15 has internal resistance (not shown). Thus, the battery voltage Vbat contains noise according to the product of the current value of the charging current Ic and a resistance value of the internal resistance. In an embodiment of the present invention, when the voltage goes to the voltage V1 lower than the voltage V2, the current value of the charging current Ic is decreased. Thus, as compared with a case where the battery 15 is continuously charged with the constant current IA, an influence of the noise exerted on the battery voltage Vbat is smaller between the voltages V1 and V2. Therefore, the control unit 61 can detect more accurate battery voltage Vbat and can cause the charging circuit 31 to start the constant-voltage charging at the desired voltage V2 with accuracy.

At a voltage very close to the voltage V2, the current value of the charging current Ic needs to be reduced in order to suppress the noise, however, in a case where the battery voltage Vbat is far from the voltage V2, if the charging current Ic is reduced, a charging time might become longer. The control unit 61 controls the charging circuit 31 so that the charging current Ic between the voltages V1 and V2 is reduced in accordance with the rise in the battery voltage Vbat. Thus, as compared with a case where the battery 15 is charged with the constant current of the current value I3 when the voltage goes to the voltage V1, for example, the charging time can be reduced.

For example, at the voltage V2, the charging current Ic can be made lower than the current value I2 at a time when the charging is completed, however in this case, the charging time becomes longer. In an embodiment of the present invention, the current value is reduced to the current value I3, which is greater than the current value I2, so that unnecessary extension of the charging time can be prevented.

The control unit 61 controls the charging circuit 31 on the basis of the first control data stored in the memory 51, and causes the charging circuit 31 to generate the charging current Ic which changes in the relationship of the quadratic curve as shown in FIG. 3. For example, if the charging current Ic is changed in steps, noise and the like might be caused by that. In an embodiment of the present invention, since the charging current Ic is gently changed using the relationship of the quadratic curve, occurrence of unnecessary noise can be prevented.

As described above, the battery voltage Vbat contains the noise according to the product of the current value of the charging current Ic and the resistance value of the internal resistance. Thus, in an embodiment of the present invention, the voltage V1 is determined on the basis of the current value I1 of the constant current IA and the resistance value of the internal resistance. For example, if the current value of the constant current IA is small and the noise is also small, the voltage V1 is set higher than that in the case where the current value of the constant current IA is great and the noise is also great. If the voltage V1 is raised when the noise is great, the voltage V2 might be false detected along with the voltage V1 by the control unit 61. Therefore, the voltage V1 is set in accordance with the current value I1 and the resistance value of the internal resistance, and thus a long charging time of charging with the constant current IA can be ensured while the influence of the noise is reduced.

The memory 51 stores the program data for the CPU 52 to execute the processing shown in FIG. 4. The CPU 52 executes the program data so as to be capable of controlling the operation of the charging circuit 31.

The control unit 61 decreases the charging current Ic on the basis of the control data stored in the memory 51, but it is not limited to that. For example, the CPU 52 may calculate the quadratic curve (function) shown in FIG. 3 and sequentially change the charging current Ic on the basis of a calculation result.

Also, the battery 15 may be another secondary battery such as a nickel-cadmium battery or the like, for example.

The above embodiments of the present invention are simply for facilitating the understanding of the present invention and are not in any way to be construed as limiting the present invention. The present invention may variously be changed or altered without departing from its spirit and encompass equivalents thereof.

What is claimed is:

1. A charging apparatus comprising:
a charging circuit configured to charge a secondary battery; and
a control circuit configured to control an operation of the charging circuit,
the control circuit including a control unit configured to control the charging circuit so that the secondary battery is charged with a constant current until a time when a battery voltage of the secondary battery goes to a first voltage, control the charging circuit so that the secondary battery is charged with a current smaller than the constant current when the battery voltage goes to the first voltage, and control the charging circuit so that the secondary battery is charged with a constant voltage when the battery voltage goes to a second voltage higher than the first voltage.

2. The charging apparatus according to claim 1, wherein
the control unit controls the charging circuit so that the secondary battery is charged with such a current as to decrease in accordance with a rise in the battery voltage when the battery voltage goes to the first voltage.

3. The charging apparatus according to claim 2, wherein
the control circuit further includes a current detection unit configured to detect a charging current of the secondary battery, and wherein
the control unit controls the charging circuit so that the charging current is lowered to a first current value when the battery voltage goes to the second voltage; and controls the charging circuit so that supply of the charging current is stopped when the current value of the charging current goes to a second current value smaller than the first current value, on the basis of a detection result of the current detection unit.

4. The charging apparatus according to claim 3, wherein
the control circuit includes a storage unit configured to store information indicating a relationship of a quadratic curve calculated on the basis of the first voltage and a current value of the constant current as well as the second voltage and the first current value, the quadratic curve having a vertex at the second voltage and the first current value, and wherein
the control unit controls the charging circuit based on the information so that the charging current is changed in magnitude in a relationship of the quadratic curve from a time when the battery voltage goes to the first voltage to a time when the battery voltage goes to the second voltage.

5. The charging apparatus according to claim 1, wherein
the first voltage is such a voltage as to be determined on the basis of the current value of the constant current and a resistance value of an internal resistance of the secondary battery.

6. The charging apparatus according to claim 2, wherein
the first voltage is such a voltage as to be determined on the basis of the current value of the constant current and a resistance value of an internal resistance of the secondary battery.

7. The charging apparatus according to claim 3, wherein
the first voltage is such a voltage as to be determined on the basis of the current value of the constant current and a resistance value of an internal resistance of the secondary battery.

8. The charging apparatus according to claim 4, wherein
the first voltage is such a voltage as to be determined on the basis of the current value of the constant current and a resistance value of an internal resistance of the secondary battery.

9. A recording medium having recorded therein a program causing a computer, which is configured to control an operation of a charging circuit configured to charge a secondary battery, to execute the steps of:
charging the secondary battery with a constant current until a time when a battery voltage of the secondary battery goes to a first voltage;
charging the secondary battery with a current smaller than the constant current when the battery voltage goes to the first voltage; and
charging the secondary battery with a constant voltage when the battery voltage goes to a second voltage higher than the first voltage.
